(19) United States
(12) Patent Application Publication
(10) Pub. No.: US 2007/0113449 A1
(43) Pub. Date: May 24, 2007

(54) Transportable outdoor sign support structure

(76) Inventor: John D. Sinchok, Peninsula, OH (US)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 11/287,534

(22) Filed: Nov. 23, 2005

(51) Int. Cl. G09F 15/00

(52) U.S. Cl. 40/607.06

(57) ABSTRACT

A portable outdoor sign support structure is formed by a rotomolding process and is provided with areas thereon for secured receipt of temporary signage. At least one of the feet of the housing is provided with an aperture for receiving an anchor, which may include sand or other particulate material for adding ballast to the housing and/or receipt of a stake such a rebar driven into the ground.

### TECHNICAL FIELD

The invention herein resides in the art of outdoor sign support structures and, more particularly, to a portable structure of that nature. Specifically, the invention relates to a lightweight rotomolded hollow structure adapted to receive and display signage in an aesthetically pleasing manner, and which is given to secure engagement to the ground upon which it rests.

### BACKGROUND ART

The use of temporary signage for a wide variety of purposes is well known. While a common usage for such signage is to display the availability of real estate for sale or rent, other temporary signs are often employed to identify the location of a gathering such as a party, reunion or the like, or to herald an event, such as a birth, birthday, or anniversary. In the past, such signs, particularly those used for the sale or rental of property, have been of a very basic nature, typically comprising a metal frame for receiving the signage, with one or two stakes extending from the metal frame for placement into the ground. The basic nature of such sign support structures are aesthetically displeasing or, at the very least, are unattractive. As a consequence, some neighborhoods and localities actually preclude their use.

There is a need in the art for transportable or temporary outdoor sign support structures that are aesthetically pleasing, yet sufficiently lightweight to be easy to transport and use. It is most desirable that such sign support structures be adaptable to various configurations and so constructed as to be given to extensive outdoor use.

### DISCLOSURE OF THE INVENTION

In light of the foregoing, it is a first aspect of the invention to provide a transportable outdoor sign support structure that is sufficiently lightweight to be easy to manipulate and use.

Another aspect of the invention is the provision of a transportable outdoor sign support structure that is given to configurations in various aesthetic designs.

Yet another aspect of the invention is the provision of a transportable outdoor sign support structure that may be readily anchored to the ground to withstand winds and the like.

Still a further aspect of the invention is the provision of a transportable outdoor sign support structure that allows for ease of removal and replacement of the signage to be carried thereby.

Still a further aspect of the invention is the provision of a transportable outdoor sign support structure that is reliable and durable in use, and given to ease of manufacture through rotomolding or the like.

The foregoing and other aspects of the invention which will become apparent as the detailed description proceeds are achieved by a transportable outdoor sign support structure, comprising: a substantially hollow housing; at least one area upon said housing delineated to receive a sign placard; and wherein said housing is configured to receive an anchor to maintain the housing in a set posture.

Other aspects of the invention are attained by a transportable outdoor sign support structure, comprising: a substantially hollow housing comprising a pair of columns, a cap bridging said columns, and a main body portion interconnecting said columns and said cap; said main body portion having delineated areas thereon for receipt of placards; and at least one of said columns having an anchor receptacle to maintain said housing in a predetermined orientation.

### DESCRIPTION OF DRAWINGS

For a complete understanding of the various aspects, structure and techniques associated with the invention, reference should be made to the following detailed description and accompanying drawings wherein:

FIG. 1 is a front elevational view of a sign support structure made in accordance with the invention;

FIG. 2 is a side elevational view of the sign support structure of FIG. 1;

FIG. 3 is a top plan view of the sign support structure of FIG. 1;

FIG. 4 is a partial bottom perspective view of the sign support structure of FIG. 1, showing a hole in the foot thereof for receipt of an anchor bar; and

FIG. 5 shows an exemplary array of sign placards that may be used in association with the sign support structure presented herein.

### BEST MODE FOR CARRYING OUT THE INVENTION

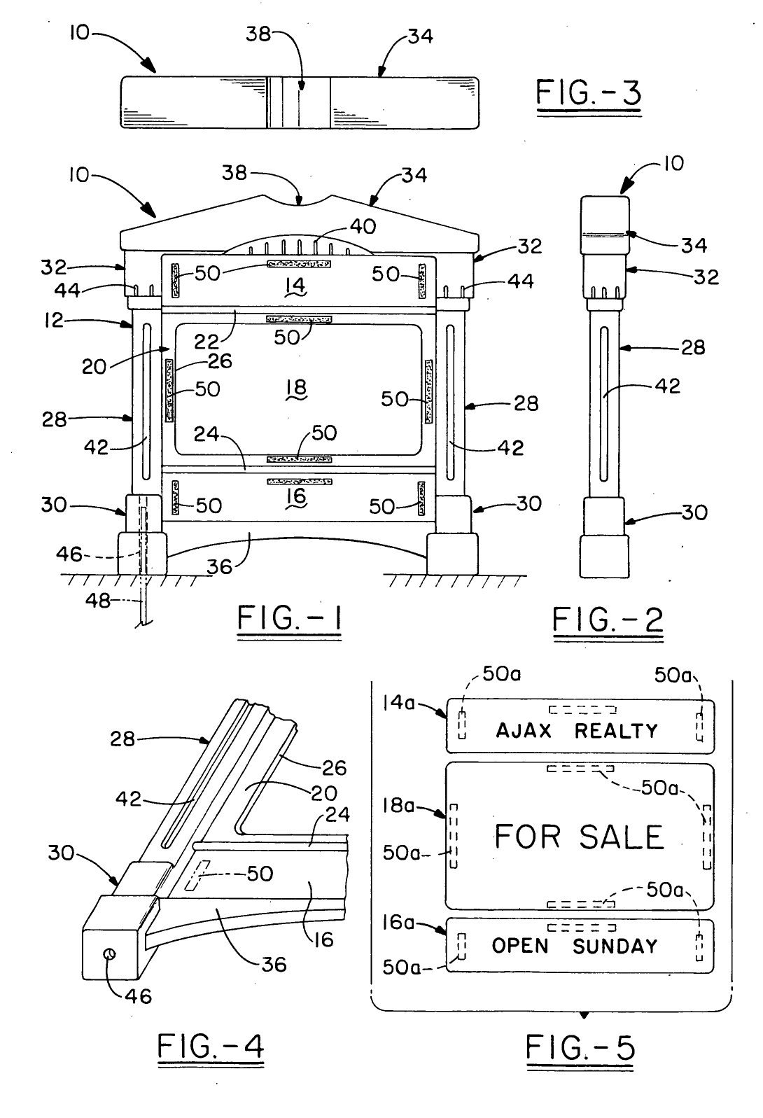

Referring now to the drawings and more particularly FIG. 1, it can be seen that a transportable outdoor sign support structure made in accordance with the invention is designated generally by the numeral 10. The sign support structure 10 includes an integral housing 12 which, in the preferred embodiment, is of a hollow nature, being formed by rotomolding or the like. It will be appreciated that the drawings show only the front of the sign support structure 10, it being understood that the back thereof is substantially identical in appearance, configuration and structure.

The housing 12 includes a top display area 14 which is a recessed flat planar surface, adapted to receive temporary signage of a size and configuration that conforms to the area 14. In similar fashion, a bottom display area 16 is provided, comprising a recessed flat planar surface adapted to receive additional temporary signage of similar configuration. There is also provided a central display area 18, comprising an aperture or window defined within a perimeter 20. The window 18 is provided to reduce the weight and cost incident to the material that would otherwise be present.

In the preferred embodiment of the invention, the display areas 14, 16 and the perimeter 20 are substantially coplanar, and are separated by protruding ribs 22, 24, which are interposed for purposes of adding strength and rigidity to the housing 12. Further, an inner surface 26, interconnecting the perimeter surfaces 20 on the opposite sides of the housing 12 add additional strength by effectively defining a beam-type construction. The inner surface 26 can best be seen in FIG. 4.

Extending along opposite sides of the housing 12, and defining the outer boundaries thereof, are a pair of posts or columns 28. At the bottom of each post or column is a foot 30 which, in this embodiment, is tiered, the tiers thereof providing additional strength, as well as aesthetic appeal. At the top of each of the posts or columns 28 are shoulders 32 which, again, are tiered for aesthetic and structural purposes. A cap or top 34 bridges the shoulders 32, as illustrated. Similarly, at the bottom of the housing 12, a base member 36 interconnects the feet 30, the base member 36 being arched for strength and aesthetics. A corresponding trough 38 is provided in the cap 34, as shown in FIGS. 1 and 3. A recessed fluted crescent 40 is provided in the cap 34 beneath the trough 38, again for strength and aesthetic purposes. Similarly, grooves or flutes 42, 44 characterize the front, back and side portions of the column 28, as shown in FIGS. 1 and 2. Those skilled in the art will appreciate that the addition of corners, recesses, ribs, tiers and the like serve to add strength an rigidity to the housing 12.

As shown in FIG. 4, a hole 46 is provided in the bottom of one or both of the feet 30. The hole 46 is adapted to receive an appropriate anchor for the sign support structure 10, to secure the same to the ground. While various anchors may be used, at least two are mentioned here by way of example only. The holes 46 may be used for filling at least the lower portion of the housing 12 with sand or other ballast, with the holes 46 subsequently being plugged with an appropriate closure member. By placing sand or other ballast into the lower portion of the housing 12, such as within the bottom display area 16, the center of gravity of the housing 12 is significantly lowered, to provide the desired stability.

It is also contemplated that a plastic or metal rod, such as metal rebar 48, may be pounded into the ground to a sufficient depth for securing purposes, with the housing 12 lifted thereover and with the hole 46 receiving the rebar 48, as shown in phantom in FIG. 1. It is contemplated the rebar 48 may extend a substantial distance up into the column 28 for stability. It is also contemplated that a rebar may be used in each of the columns 28, to prevent any tendency for the housing 12 to pivot about a single piece of rebar 48 under high wind conditions.

As shown in FIG. 1, the signage areas 14, 16 and the perimeters 20 are provided with appropriate fasteners 50 for receiving temporary sign placards. According to one embodiment of the invention, the fasteners 50 comprise hook and loop structures, with one of the mating structures being present on the housing 12, and the other of the mating structures being present on the back of the sign placard.

With reference to FIG. 5, a representative sign placard may be seen. As illustrated, a sign placard 14a is provided for receipt by the area 14, a sign placard 16a for receipt by the area 16, and a sign placard 18a for receipt over the window 18 and secured upon the perimeter 20. Each of the placards 14a, 16a, and 18a is provided with a mating fastener 50a for engagement with the corresponding fastener element 50 upon the housing 12.

Those skilled in the art will appreciate that the structure presented herein may take on any of various aesthetic configurations. While one exemplary embodiment has been shown, others, replicating bricks, shingles, stucco, or the like may be employed. Similarly, the architectural arrangement may also vary, depicting colonial, contemporary, gothic, or similar appearances.

It will further be appreciated by those skilled in the art that the hollow housing 12 may be readily formed using various manufacturing techniques, although rotomolding is preferred. Similarly, the material employed for the housing 12 may vary, although it is presently contemplated that the material be such that no further finishing of the housing 12 be required once it is taken from the mold. In that regard, the material is pigmented for the desired color. A preferred material for the manufacturing process is a linear low density polyethylene.

Thus it can be seen that the aspects of the invention have been satisfied by the structure presented above. While in accordance with the patent statutes only the best known and preferred embodiment of the invention has been presented and described in detail, the invention is not limited thereto or thereby. Accordingly, for an appreciation of the true scope and breadth of the invention reference should be made to the following claims.

What is claimed is:

1. A transportable outdoor sign support structure, comprising:
a substantially hollow housing;
at least one area upon said housing delineated to receive a sign placard; and
where said housing is configured to receive an anchor to maintain the housing in a set posture.

2. The outdoor sign support structure according to claim 1, wherein said housing has a hole therein to receive said structure.

3. The outdoor sign support structure according to claim 2, wherein said anchor comprises a ballast material at least partially filling said hollow housing.

4. The outdoor sign support structure according to claim 2, wherein said anchor comprises a stake extending through said hole and upwardly within said hollow housing.

5. The outdoor sign support structure according to claim 4, wherein said housing comprises a plurality of delineated areas for removable receipt of sign placards.

6. The outdoor sign support structure according to claim 5, wherein said delineated areas comprise an open window having a perimeter frame thereabout.

7. The outdoor sign support structure according to claim 6, further comprising mating fasteners on said perimeter frame and said placard.

8. The outdoor sign support structure according to claim 7, wherein said mating fasteners comprise hook and loop elements.

9. The outdoor sign support structure according to claim 6, wherein certain of said delineated areas comprise flat planar surfaces.

10. The outdoor sign support structure according to claim 9, wherein said flat planar surfaces and said placards having mating connection thereon.

11. The outdoor sign support structure according to claim 5, wherein at least certain of said delineated areas are separated from other of said delineated areas by reinforcing ribs.

12. The outdoor sign support structure according to claim 5, wherein said housing comprises a pair of hollow columns having feet at lower ends thereof, a cap bridging an upper end thereof, and a main body portion interconnecting said columns and cap, said main body portion characterized by said delineated areas.

13. The outdoor sign support structure according to claim 12, wherein said delineated areas are coplanar.

14. A transportable outdoor sign support structure, comprising:
a substantially hollow housing comprising a pair of columns, a cap bridging said columns, and a main body portion interconnecting said columns and said cap;
said main body portion having delineated areas thereon for receipt of placards; and
at least one of said columns having an anchor receptacle to maintain said housing in a predetermined orientation.

15. The transportable outdoor sign support structure as recited in claim 14, wherein said anchor receptacle comprises a hole in a bottom surface of at least one of said columns for receiving said anchor.

16. The transportable outdoor sign support structure as recited in claim 15, wherein said anchor comprises a stake passing through said hole and upwardly with said at least one of said columns.

17. The transportable outdoor sign support structure as recited in claim 16, further comprising mating fasteners between said delineated areas and said placards.

18. The transportable outdoor sign support structure as recited in claim 17, wherein said mating fasteners comprise hook and loop members.

19. The transportable outdoor support structure as recited in claim 18, wherein at least one of said delineated areas comprises an open window having a planar perimeter.

20. The transportable outdoor support structure as recited in claim 19, wherein at least one of said delineated areas comprises a flat planar area, coplanar with said planar perimeter.
